(19) United States
(12) Patent Application Publication
(10) Pub. No.: US 2023/0144132 A1
(43) Pub. Date: May 11, 2023

(54) NONPNEUMATIC TIRE AND WHEEL ASSEMBLY

(71) Applicant: The Goodyear Tire & Rubber Company, Akron, OH (US)

(72) Inventors: Wesley Glenn Sigler, Barberton, OH (US); Joseph Carmine Lettieri, Hudson, OH (US); Ann Elizabeth Myers, Cuyahoga Falls, OH (US); Andrew James Miller, Akron, OH (US); Kurtis Dale Kandel, Louisville, OH (US)

(21) Appl. No.: 18/048,137

(22) Filed: Oct. 20, 2022

Related U.S. Application Data
(60) Provisional application No. 63/277,036, filed on Nov. 8, 2021.

(51) Int. Cl. B60C 7/14

(52) U.S. Cl. CPC B60C 7/146

(57) ABSTRACT

A nonpneumatic tire and wheel assembly which includes a wheel, and a spoke ring structure having an inner ring that is mounted on an outer surface of the wheel. The spoke ring structure has a plurality of spoke members, and an outer tread ring is mounted on the outer circumference of the spoke ring.

### FIELD OF THE INVENTION

The invention relates in general to a vehicle wheel, and more particularly to a nonpneumatic tire and wheel assembly.

### BACKGROUND OF THE INVENTION

The pneumatic tire has been the solution of choice for vehicular mobility for over a century. The pneumatic tire is a tensile structure. The pneumatic tire has at least four characteristics that make the pneumatic tire so dominate today. Pneumatic tires are efficient at carrying loads, because all of the tire structure is involved in carrying the load. Pneumatic tires are also desirable because they have low contact pressure, resulting in lower wear on roads due to the distribution of the load of the vehicle. Pneumatic tires also have low stiffness, which ensures a comfortable ride in a vehicle. The primary drawback to a pneumatic tire is that it requires compressed fluid. A conventional pneumatic tire is rendered useless after a complete loss of inflation pressure.

A tire designed to operate without inflation pressure may eliminate many of the problems and compromises associated with a pneumatic tire. Neither pressure maintenance nor pressure monitoring is required. Structurally supported tires such as solid tires or other elastomeric structures to date have not provided the levels of performance required from a conventional pneumatic tire. A structurally supported tire solution that delivers pneumatic tire-like performance would be a desirous improvement.

Non-pneumatic tires are typically defined by their load carrying efficiency. “Bottom loaders” are essentially rigid structures that carry a majority of the load in the portion of the structure below the hub. “Top loaders” are designed so that all of the structure is involved in carrying the load. Top loaders thus have a higher load carrying efficiency than bottom loaders, allowing a design that has less mass.

Thus an improved non-pneumatic tire is desired that has all the features of the pneumatic tires without the drawback of the need for air inflation is desired. It is also desired to have an improved nonpneumatic tire that has longer tread life as compared to a pneumatic tire of the same size.

### Definitions

“Aspect Ratio” means the ratio of a tire’s section height to its section width.

“Axial” and “axially” means the lines or directions that are parallel to the axis of rotation of the tire.

“Belt Structure” or “Reinforcing Belts” means at least two annular layers or plies of parallel cords, woven or unwoven, underlying the tread, unanchored to the bead, and having both left and right cord angles in the range from 17° to 27° with respect to the equatorial plane of the tire.

“Breakers” or “Tire Breakers” means the same as belt or belt structure or reinforcement belts.

“Circumferential” means lines or directions extending along the pewheeleter of the surface of the annular tread perpendicular to the axial direction; it can also refer to the direction of the sets of adjacent circular curves whose radii define the axial curvature of the tread as viewed in cross section.

“Radial” and “radially” mean directions radially toward or away from the axis of rotation of the tire.

### BRIEF DESCRIPTION OF THE DRAWINGS

The invention will be described by way of example and with reference to the accompanying drawings in which:

FIG. 1 is a front view of a nonpneumatic tire and wheel assembly of the present invention;

FIG. 2 is a cross-sectional view of the nonpneumatic tire and wheel assembly of FIG. 1;

FIG. 3 is a close-up front view of a portion of the spoke ring assembly;

FIG. 4 is an exploded view of the nonpneumatic tire and wheel assembly of FIG. 1;

FIG. 5 is a cross-sectional view of one half of the nonpneumatic tire and wheel assembly of FIG. 1;

FIG. 6 is a close-up cross-sectional view of the spoke structure of the nonpneumatic tire and wheel assembly of FIG. 1;

FIG. 7 is a cross-sectional perspective view of the spoke structure and tread;

FIG. 8A is a side view of the outboard spoke ring, while FIG. 8B is a perspective side view of the outboard spoke ring of FIG. 8A;

FIG. 9A is a side view of the middle spoke ring, while FIG. 9B is a perspective side view of the middle spoke ring of FIG. 9A;

FIG. 10A is a side view of the outboard spoke ring, while FIG. 10B is a perspective side view of the outboard spoke ring of FIG. 10A; and

FIG. 11 is a cross-sectional view of a shearband of the nonpneumatic tire and wheel assembly of FIG. 1.

### DETAILED DESCRIPTION OF THE INVENTION

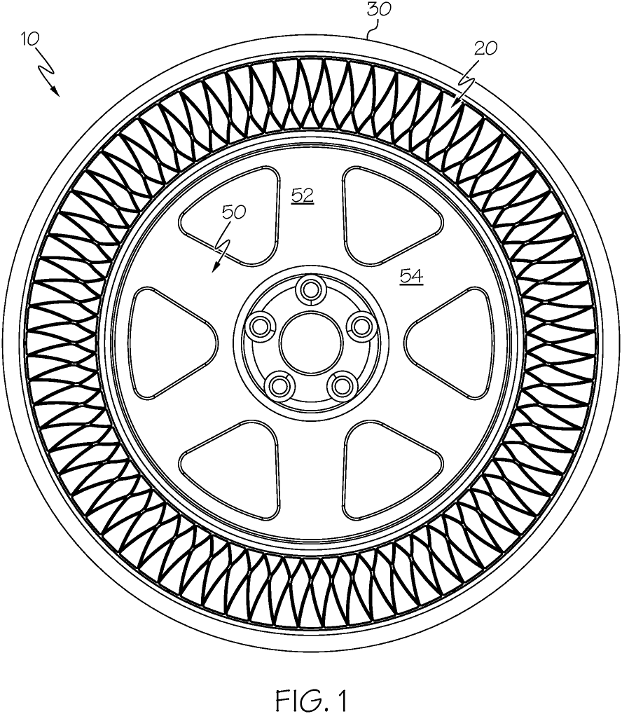

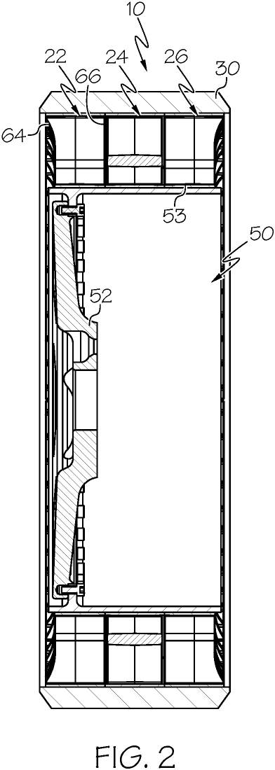

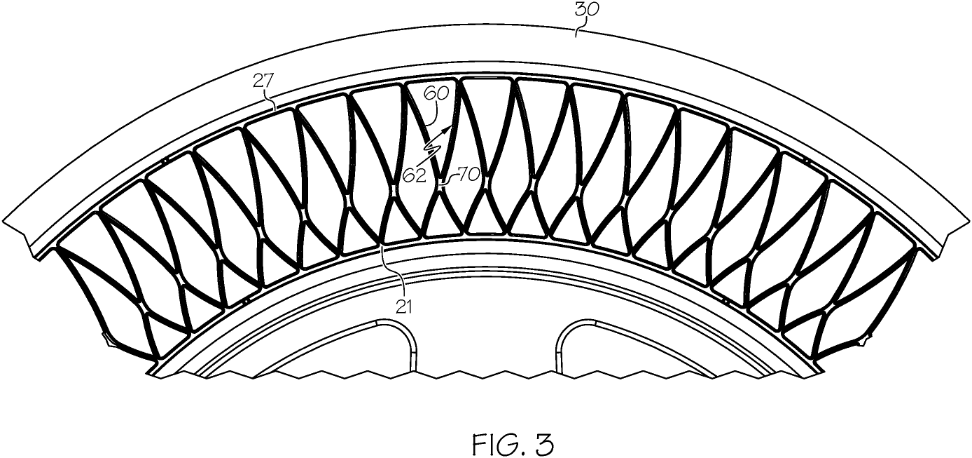

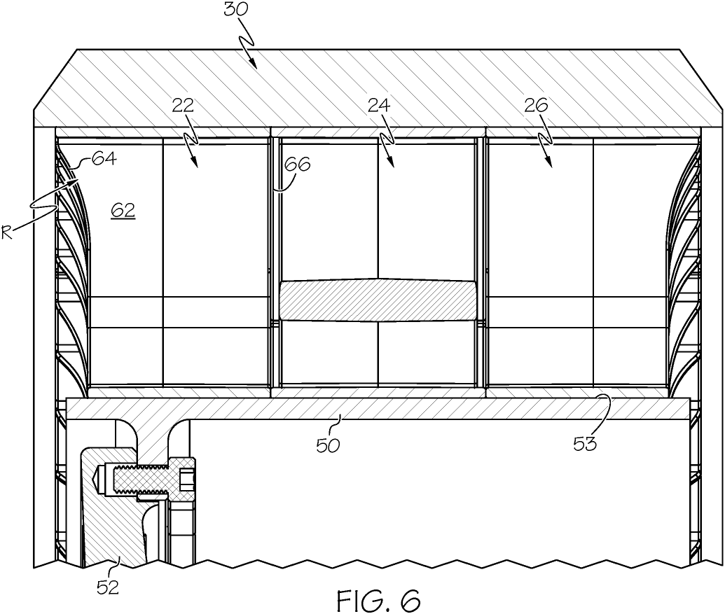

Referring to FIGS. 1 through 10, a nonpneumatic tire and wheel assembly 10 of the present invention is shown. The nonpneumatic tire and wheel assembly 10 includes an outer annular tread ring 30, a spoke ring 20, and a wheel 50. The outer annular tread ring 30 is preferably a one piece annular structure that is formed of a polymer, rubber or other desired elastomer. The tread ring 30 may be molded and cured as a one piece ring, and is mounted on the outer periphery of the spoke ring. The outer tread surface 31 of the tread ring 30 may include tread elements such as ribs, blocks, lugs, grooves, and sipes as desired in order to improve the performance of the tire in various conditions.

The shear band 31 is preferably an annular structure that is located radially inward of the tire tread 30 and functions to transfer the load from the bottom of the tire which is in contact with the ground to the spokes and to the hub, creating a top loading structure. The annular structure 31 is called a shear band because the preferred form of deformation is shear over bending.

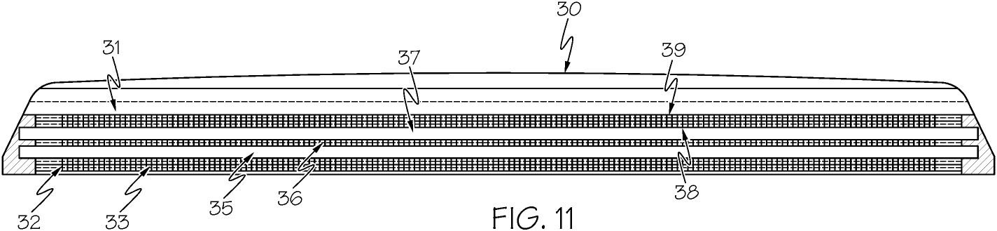

A first embodiment of a shear band 31 is shown in FIG. 11. The shear band may include a first, second and third reinforcement layer 32, 33, 36. Each reinforcement layer is formed of a plurality of closely spaced parallel reinforcement cords. The parallel reinforcement cords may be formed from a calendared fabric so that the reinforcement cords are embedded in a elastomeric coating. Preferably, each reinforcement layer 32,33,36 is formed from spirally winding a single end cord. Preferably, the single end cord has multiple filaments.

The first and second reinforcement layers 320,330 are preferably the radially innermost reinforcement layers of the shear band 300, and the second reinforcement layer 330 is located radially outward of the first membrane layer. The third reinforcement layer 360 is located radially outward of the second reinforcement layer 33. The inextensible reinforcement cords of each layer 32,33, 36 are preferably angled in the range of five degrees or less with respect to the tire equatorial plane. The reinforcing cords of the first and second reinforcement layers 32,33 may be suitable tire belt reinforcements, such as monofilaments or cords of steel, aramid, and/or other high modulus textiles. For example, the reinforcing cords may be steel cords of four wires of 0.28 mm diameter (4 x 0.28) or 0.22 mm diameter. In another example, the reinforcing cords may be steel cords of 6 wires, with five wires surrounding a central wire (5 +1) construction.

The third reinforcement layer 36 is separated from the second reinforcement layer 33 by a first shear layer 35. The shear band 31 further comprises a second shear layer 37 located radially outward of the third reinforcement layer 36. The first and second shear layer 35,37 is formed of an elastomer or rubber having a shear modulus in the range of 3 MPa to 30 MPa, or more preferably in the range of 10 MPa to 20 MPa. The shear modulus is defined using a pure shear deformation test, recording the stress and strain, and determining the slope of the resulting stress-strain curve.

The shear band 31 further includes a first angled belt 38 and a second angled belt 39. The first angled belt 38 is located radially outward of the second shear layer 37, and the second angled belt 39 is located radially outward of the first angled belt 380. The first and second angled belts 380, 390 each have parallel reinforcement cords that are embedded in an elastomeric coating. The parallel reinforcement cords are preferably angled in the range of 15 to 30 degrees with respect to the tire equatorial plane. Preferably, the angle of the parallel reinforcement cords is in the range of 20-25 degrees. Preferably, the angle of the reinforcement cords of the first angled belt is in the opposite direction of the angle of the reinforcement cords in the second angled belt. It is additionally preferred that the reinforcement cords are inextensible.

The shear band has an overall shear stiffness GA. The shear stiffness GA may be determined by measuring the deflection on a representative test specimen taken from the shear band. The upper surface of the test specimen is subjected to a lateral shear force F. The test specimen is a representative sample taken from the shear band and having the same radial thickness as the shearband. The shear stiffness GA is then calculated from the following equation: GA=F*L/ΔX, where F is the shear load, L is the shear layer thickness, and ΔX is the shear deflection. It is preferred that GA be in the range of about 15,000 N to 35,000 N, and more preferably, about 25,000 N.

The shear band has an overall bending stiffness EI. The bending stiffness EI may be determined from beam mechanics using the three point bending test. It represents the case of a beam resting on two roller supports and subjected to a concentrated load applied in the middle of the beam. The bending stiffness EI is determined from the following equation: EI = PL3/48* ΔX, where P is the load, L is the beam length, and ΔX is the deflection. It is preferred that EI be in the range of 270 E6 N-mm2 plus or minus 25%.

### Spoke Ring Structure

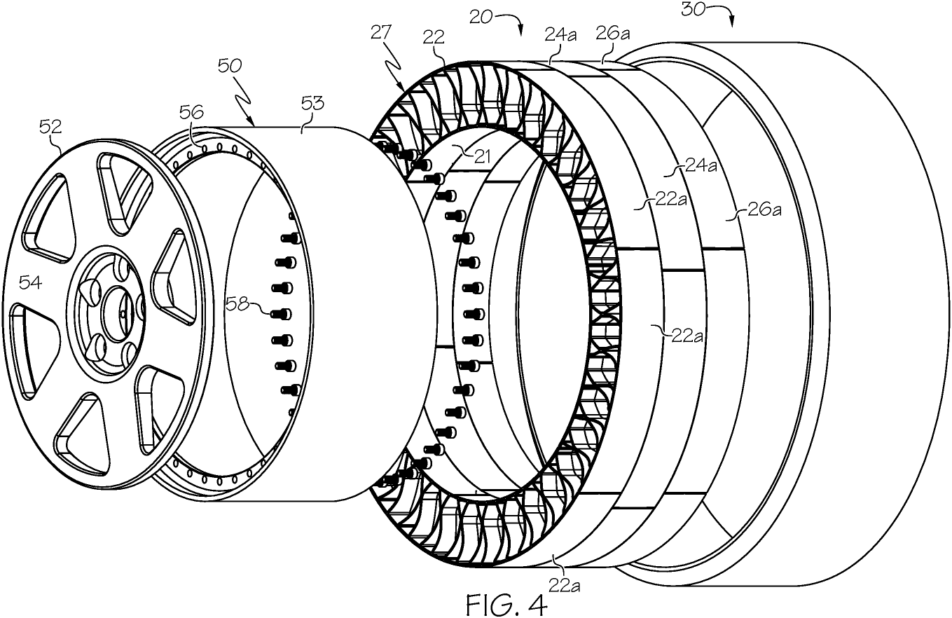

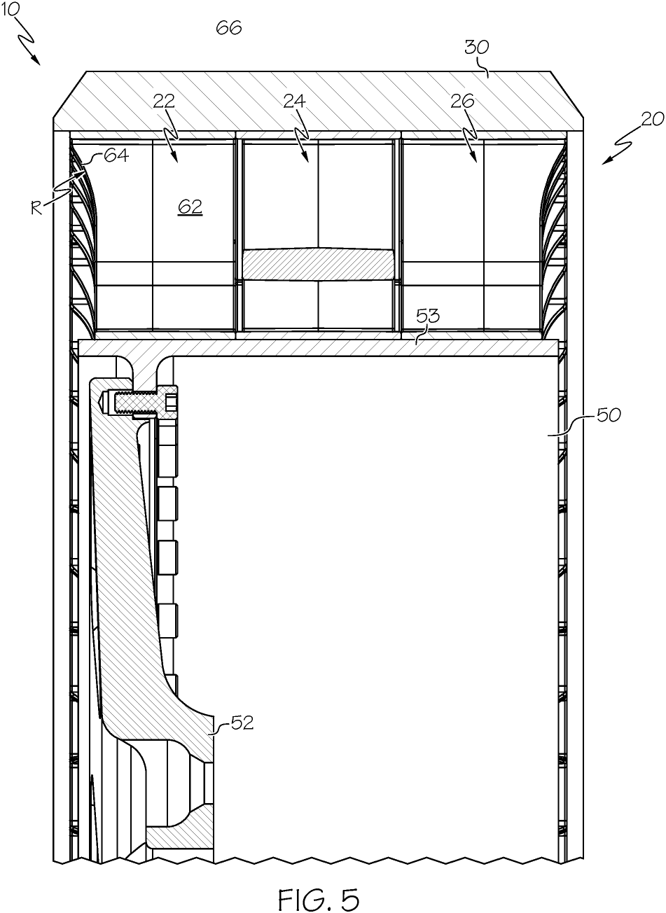

The nonpneumatic tire and wheel assembly 10 further includes a spoke structure 20. The spoke structure 20 has at least one layer of spoke rings 22, and preferably at least two spoke rings 22,24. FIGS. 4-5 illustrates a nonpneumatic tire and wheel assembly having three spoke rings 22,24,26.

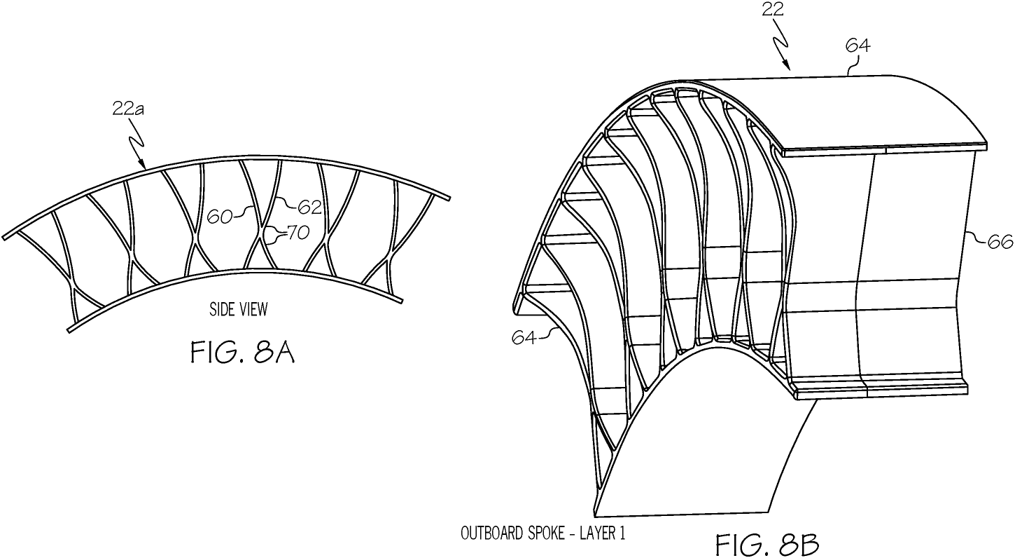

Each spoke ring 22,24,26 may be an integrally formed ring or may be formed from a plurality of sectors 22a that are assembled to form a ring 22. FIG. 8a illustrates a sector 22a used to form the spoke ring 22. There are 6 sectors used to form the spoke ring 22, although there may be more or less sectors to form the ring. As shown in FIG. 8b, the spoke ring 22 is the outboard spoke ring that faces axially outward when mounted on a vehicle. The spoke ring 22 has a plurality of X shaped spokes formed from a first spoke member 60 that is joined to a second spoke member 62. The first and second spoke member 60,62 are joined together at a junction 70 to form an X shaped spoke. The first and second spoke members 60,62 may be straight or curved. The number of spokes may vary, for example, from 15 to 60 depending upon the vehicle weight and desired spring rate. The outboard spoke ring has an axially outer edge 64 that is radiused. The outboard spoke ring 22 has an axially inner edge 66 that is not radiused, and is straight in the radial direction. The outer tread ring 30 extends axially outward of the center disk 52 of the wheel, so that the wheel is recessed to reduce noise.

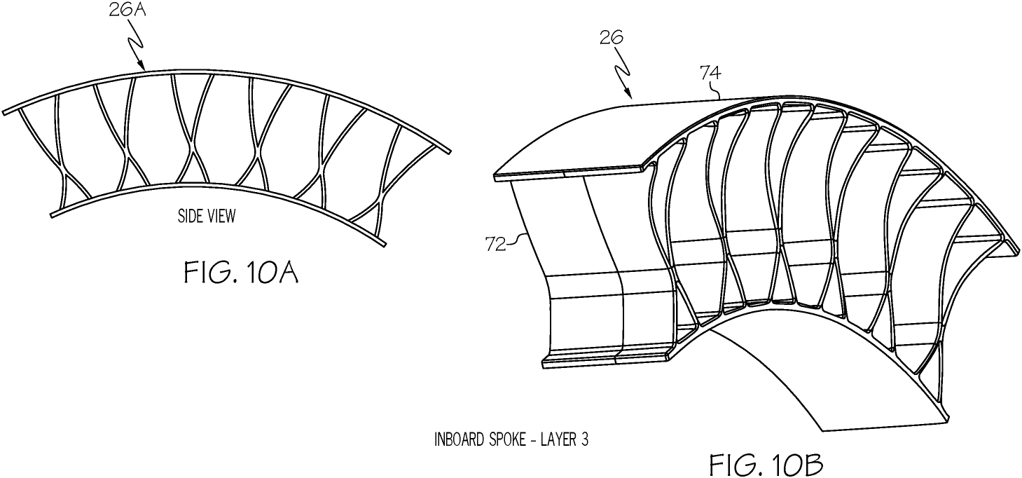

FIG. 10A illustrates a sector of the inboard spoke ring 26. The inboard spoke ring 26 is the same as the spoke ring 22, except for the following differences. The axially outer edge 74 of the inboard spoke ring 26 is radiused, while the axially inner edge 72 is straight, or aligned with the radial direction.

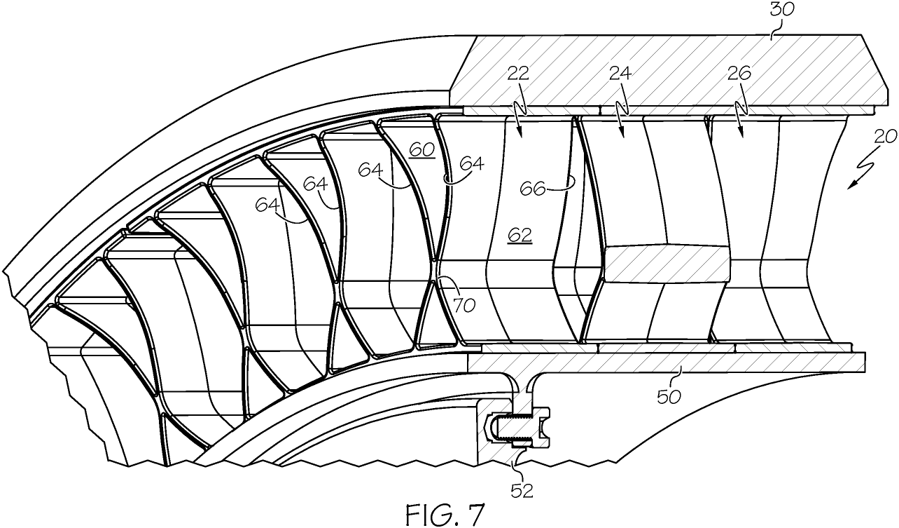

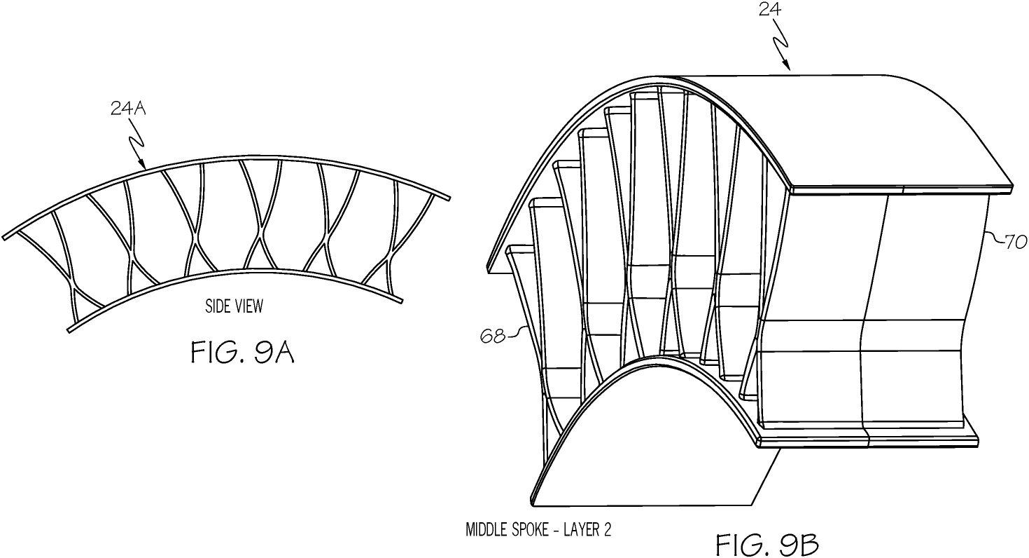

FIG. 9A illustrates a sector of the middle spoke ring 24. The middle spoke ring 24 is the same as the spoke ring 22, except for the following differences. The axially outer edge 68 and axially inner edge 70 of the middle spoke ring 24 is straight, or aligned with the radial direction. Additionally, as shown in FIG. 7, the middle spoke ring is clocked so that it is not in alignment with the X spokes of spoke rings 22 or 26.

Each spoke ring 22,24,26 has an inner portion 21 that is mounted on the wheel rim mounting surface 53, and an outer portion 27 that is connected to the inner surface of the tread ring. Preferably, the inner portion 21 has an interference fit on the outer rim mounting surface 53 of the wheel 50.

The radius R of the radiused outer edges may range from 1 to 2 inches. The scalloped or radiused outer edges allow the wheel to be recessed axially inward of the spoke and tread ring structure.

The spoke ring structures 22,24,26 are preferably made of a resilient and/or moldable polymeric material such as but not limited to, a thermoplastic elastomer, natural rubber, styrene butadiene rubber, polybutadiene rubber or EPDM rubber or a blend of two or more of these materials which can be utilized in either injection molding or compression molding. The material of the spoke ring structure is selected based upon one or more of the following material properties. The tensile (Young’s) modulus of the spoke disk material is preferably in the range of 5 MPa to 100 MPa, and more preferably in the range of 10 MPa to 70 MPa.

The wheel 50 is best shown in FIG. 4, and has an annular outer rim mounting surface 53 for receiving the inner portion 21 of each of the spoke ring structures 22,24,26. The wheel further includes a recessed center disk 52 having a plurality of bolt holes 54 for connecting the wheel assembly to a vehicle. The center disk is mounted to an outer flange 56 via a plurality of bolts 58. The wheel is preferably formed of powder coated aluminum.

Variations in the present invention are possible in light of the description of it provided herein. While certain representative embodiments and details have been shown for the purpose of illustrating the subject invention, it will be apparent to those skilled in this art that various changes and modifications can be made therein without departing from the scope of the subject invention. It is, therefore, to be understood that changes can be made in the particular embodiments described which will be within the full intended scope of the invention as defined by the following appended claims.

What is claimed is:

1. A nonpneumatic tire and wheel assembly comprising: a wheel, a spoke ring structure formed of one or more segments arranged to form an annular spoke ring, wherein the spoke ring structure has a plurality of spoke members, and an outer tread ring mounted on the outer circumference of the spoke ring.

2. The nonpneumatic tire and wheel assembly of claim 1 wherein the tread ring has one or more layers of reinforced fabric formed of parallel reinforcement cords, wherein the reinforcement cords are aligned in the circumferential direction.

3. The nonpneumatic tire and wheel assembly of claim 1 wherein the spoke members of the spoke ring structure are joined together at a junction to form an X shaped spoke.

4. The nonpneumatic tire and wheel assembly of claim 1 wherein the wheel is recessed within the tire and wheel assembly.

5. The nonpneumatic tire and wheel assembly of claim 1 wherein at least one spoke member has a radially inner portion that has an axial width less than an axial width of a radially outer portion of the spoke member.

6. The nonpneumatic tire and wheel assembly of claim 1 wherein each spoke member has an axially outer edge, wherein at least one of the axially outer edges is radiused.

7. The nonpneumatic tire and wheel assembly of claim 1 wherein the nonpneumatic tire and wheel assembly is formed by three dimensional printing.

8. The nonpneumatic tire and wheel assembly of claim 1 wherein the spoke ring structure is formed of a polymer material having a tensile modulus in the range of 15 to 100 MPa.

9. A nonpneumatic tire and wheel assembly comprising: a wheel, a spoke ring structure having an inner ring that is mounted on an outer rim mounting surface of the wheel, wherein the spoke ring structure has a plurality of spoke members, and an outer tread ring mounted on the outer circumference of the spoke ring, wherein the wheel is axially recessed within the nonpneumatic tire and wheel assembly.

10. A nonpneumatic tire and wheel assembly comprising: a wheel, a spoke ring structure having an inner ring that is mounted on an outer rim mounting surface of the wheel, wherein the spoke ring structure has a plurality of spoke members, and an outer tread ring mounted on the outer circumference of the spoke ring, wherein at least one of the spoke members has an axially outer edge, wherein the axially outer edge is radiused.

11. A nonpneumatic tire and wheel assembly comprising: a wheel, a spoke ring structure having an inner ring that is mounted on an outer rim mounting surface of the wheel, wherein the spoke ring structure has a plurality of spoke members, and an outer tread ring mounted on the outer circumference of the spoke ring, wherein each spoke member has a radially inner portion and a radially outer portion, wherein the radially inner portion has an axial width less than the radially outer portion.
